(19) United States
(12) Patent Application Publication
(10) Pub. No.: US 2026/0131259 A1
(43) Pub. Date: May 14, 2026

(54) SALT AND SUGAR SEPARATION PROCESS

(71) Applicant: CORN PRODUCTS DEVELOPMENT, INC., WESTCHESTER, IL (US)

(72) Inventor: Dmitry KAZACHKIN, Bridgewater, NJ (US)

(21) Appl. No.: 19/119,276

(22) PCT Filed: Oct. 18, 2023
(86) PCT No.: PCT/US2023/077158

§ 371 Date: Apr. 8, 2025

Related U.S. Application Data
(60) Provisional application No. 63/418,081, filed on Oct. 21, 2022.

(51) Int. Cl. B01D 15/18; B01D 15/20; B01D 15/36; B01J 39/05; C13K 13/00

(52) U.S. Cl. CPC B01D 15/1821; B01D 15/203; B01D 15/362; B01J 39/05; C13K 13/007

(57) ABSTRACT

A method of separating and recovering a first carbohydrate from a feed solution comprising two or more carbohydrates and salts using a chromatography separation system which comprises one or more strong acid cation exchange resin, and recovering at least one fraction enriched in the first carbohydrate.

Disclosed herein is a process for separating and purifying carbohydrates. More specifically this specification discloses processes for the separation and purification of allulose from salts and other sugars.

Separation and purification of biomolecules such as carbohydrates remains one of the most challenging aspects of synthetic carbohydrate chemistry. The numerous variations in the physical and functional properties of carbohydrates complicates the development of methods that are effective at analyzing, separating, and purifying such carbohydrates. Some carbohydrates such as, e.g., rare sugars and steviol glycosides occur in very small quantities in nature and, as such, are typically made using, e.g., fermentation or enzyme conversion. The resulting carbohydrates require efficient (as to time and to cost) separation and recovery from other materials from their underlying natural source or from their fermentation or conversion media. For various commercial and therapeutic applications, the acceptable carbohydrate purity level is very high, e.g., greater than 90%. Various chromatographic methods, including liquid chromatographic separations have garnered considerable interest owing to their industrial and analytical applications.

Batch processes such as. e.g., chromatography can be used to separate carbohydrates, such as, e.g., sugars from a feed solution by passing the feed solution through the fixed bed of an ion exchange column followed by an eluent such as de-ionized water. These carbohydrates are subsequently separated from the feed solution via the eluent, which flows through part of the stationary resin together with the feed solution. This chromatographic separation can be carried out in a long column packed with a stationary ion-exchange resin or by using a Simulated Moving Bed (SMB). The SMB can be used at industrial scale in a continuous process that separates and/or purifies the carbohydrates. As a result, the SMB technology provides a significant economic advantage in manufacturing operations compared to batch separation methods including crystallization and stepwise chromatographic separations. The SMB can also be used to separate chemical compounds that would be difficult or impossible to separate by any other means. There is considerable interest in using ion-exchange technology to desalt carbohydrates such as, e.g., sugars (i.e., separating sugars and salts to provide salt-free fractions). While the ion-exchange technology can be used to separate salt from the carbohydrates, such as, e.g., sugars, it is not always effective or economically feasible to use ion-exchange, particularly when salt loading is too high. Thus, there is a need in processes that are directed to making carbohydrates, such as, e.g., sugars, for simple, efficient, and cost-effective separation and purification techniques to provide high purity carbohydrates.

In one aspect the technology disclosed in this specification pertains to a method of separating and recovering a first carbohydrate from a feed solution comprising two or more carbohydrates and salts, the method comprising passing the feed solution through a chromatography separation system which comprises one or more strong acid cation exchange resin and recovering a first fraction enriched in said first carbohydrate and a second fraction comprising one or more carbohydrates and salts.

### BRIEF DESCRIPTION OF THE DRAWINGS

The details of one or more embodiments are set forth in the accompanying drawings and the description below. Other features, aspects, and advantages of the disclosure will become apparent from the description, the drawings, and the claims.

FIG. 1 depicts a process flow chart of a process for separation and recovery of one or more carbohydrate molecules in one illustrative embodiment of the instant process.

FIG. 2 depicts a process flow chart of an alternate process for separation and recovery of one or more carbohydrate molecules in an illustrative embodiment of the instant process.

FIG. 3 shows chromatographic elution curves (Brix vs. Bed Volume (BV)) corresponding to Example 2 showing elution curves corresponding to allulose, glucose and fructose, using DOWEX MONOSPHERE™ 99Ca/310 resin.

FIG. 4 shows chromatographic elution profiles for individual components of injected mixture corresponding to Example 2 showing elution curves corresponding to allulose, glucose and fructose, using DIAION™ UBK-555 99Ca/220 resin.

FIG. 5A shows chromatographic elution profiles for carbohydrates (Brix vs. Bed Volume (BV)) corresponding to Example 3 using DOWEX MONOSPHERE™ 99Ca/310 resin either fresh or exposed for a period of time (“poisoned”) to feed solution. Profiles of salts (measured as conductivity response) are also measure and plotted on the same graph (FIG. 5A).

FIG. 5B shows chromatographic elution profiles (Brix vs. Bed Volume (BV)) corresponding to Example 3 showing only total solids elution for fresh DOWEX MONOSPHERE™ 99Ca/310 resin, used resin (“poisoned”), and used resin after regeneration with 10% calcium chloride.

In at least one embodiment, the strong acid cation exchange resin includes divalent cations, monovalent cations, cations equilibrated with the cations present in the feed solution, or a combination thereof. In at least one embodiment, the divalent cations are selected from the group consisting of Ca²⁺, Co²⁺, Mg²⁺, Mn²⁺ and the monovalent cations are selected from the group consisting of Na⁺, K⁺ or a combination of the cations with variable proportions. In at least one embodiment, the strong acid cation exchange resin is in a gel bead form. In at least one embodiment, the strong acid cation exchange resin has a median bead diameter of from 100 to 500 microns. In at least one embodiment, the strong acid cation exchange resin is a resin with a polystyrene matrix. In at least one embodiment, the strong acid cation exchange resin is cross-linked with divinylbenzene. In at least one embodiment, the strong acid cation exchange resin is functionalized with an alkaline earth metal ion or a combination of two or more thereof. In at least one embodiment, the eluent for the ion chromatography separation system is water.

In at least one embodiment, the feed solution is a cell lysed solution comprising an aqueous mixture of inorganic salts, biological fragments, metabolic products of cell, enzymes released by the cell, and carbohydrates. In at least one embodiment, the one or more carbohydrate molecules comprise a rare sugar and the method comprises recovering a fraction enriched in a rare sugar. In at least one embodiment, the rare sugar is allulose. In at least one embodiment, the rare sugar fraction in the feed solution has a purity of 10% to 80% on a dry solids basis. In at least one embodiment, the purity of the recovered rare sugar fraction is at least 10% greater than the purity of the rare sugar fraction in the feed solution on a dry solids basis. In at least one embodiment, the recovered rare sugar fraction has a purity of 60% or more on a dry solids basis. In at least one embodiment, the recovered rare sugar fraction has a purity of more than 90% on a dry solids basis. In at least one embodiment, the method provides a rare sugar yield of at least 80%.

In at least one embodiment, the rare sugar components are separated from components selected from sucrose, fructose, dextrose, oligomers of dextrose, fragments of RNA and/or DNA, biological endotoxins, amino acids, inorganic salts, and combinations thereof.

In at least one embodiment, the chromatography separation system comprises a chromatographic method selected from a simulated moving bed, a sequential simulated moving bed, a batch method, an intermittent simulated moving bed, or combinations thereof. In at least one embodiment, the chromatography separation system comprises ion chromatography or sequential simulated moving bed.

In at least one embodiment, the chromatographic separation system comprises a plurality of separation zones and collection zones. In at least one embodiment, the chromatographic separation system comprises a regeneration zone for continuous or periodic regeneration of the resin, wherein a regeneration solution is applied to the bed. In at least one embodiment, the regeneration solution comprises NaOH, NaCl, KOH, KCl, Ca(OH)₂, or CaCl₂.

Another aspect of many embodiments of the invention relates to a method of separating and recovering a first carbohydrate from a feed solution comprising two or more carbohydrates and salts, said method comprising: passing the feed solution through a first chromatography separation system which comprises one or more strong acid cation exchange resin functionalized with a monovalent metal ion; recovering a first fraction enriched in said two or more carbohydrates and a second fraction comprising salts along with admixture of carbohydrates not recovered in first fraction; subjecting the first fraction to an ion exchange purification process to obtain a third fraction comprising two or more carbohydrates; passing the third fraction through a second chromatography separation system which comprises one or more strong acid cation exchange resin functionalized with an divalent metal ion; and recovering a fourth fraction enriched in said first carbohydrate and a fifth fraction comprising one or more further carbohydrates.

In at least one embodiment, the monovalent metal ions are selected from Na⁺, K⁺ or a combination thereof. In at least one embodiment, the divalent metal ions are selected from the group consisting of Ca²⁺, Co²⁺, Mg²⁺, Mn²⁺ or a combination of two or more thereof. In at least one embodiment, the first chromatography separation system comprises ion chromatography. In at least one embodiment, the second chromatography separation system comprises a sequential simulated moving bed method. In at least one embodiment, the first carbohydrate comprises a rare sugar and the method comprises recovering a fraction enriched in a rare sugar. In at least one embodiment, the rare sugar is allulose. In at least one embodiment, the method provides a rare sugar yield of at least 80%. In at least one embodiment, the one or more further carbohydrate molecules in the fifth fraction is selected from the group consisting of fructose, dextrose, and saccharides having a degree of polymerization greater than 2.

Another aspect of many embodiments of the invention relates to a method of separating and recovering allulose from a feed solution, the method comprising: passing the feed solution through a chromatography separation system which comprises one or more strong acid cation exchange resin functionalized with Ca²⁺ and recovering from said feed solution at least one fraction enriched in allulose, wherein said fraction further comprises a reduced content of salts, biologically derived fragments and other sugars.

Yet another aspect of many embodiments of the invention relates to a method of separating and recovering allulose from a feed solution comprising two or more carbohydrates and salts, said method comprising: passing the feed solution through a first chromatography separation system which comprises one or more strong acid cation exchange resin functionalized with Nat; recovering a first fraction enriched in said two or more carbohydrates and a second fraction comprising salts; subjecting the first fraction to an ion exchange purification process to obtain a third fraction comprising two or more carbohydrates; passing the third fraction through a second chromatography separation system which comprises one or more strong acid cation exchange resin functionalized with Ca²⁺; recovering a fourth fraction enriched in allulose and a fifth fraction comprising one or more carbohydrates.

Another aspect of many embodiments of the invention relates to a method of separating and recovering allulose from a feed solution, the method comprising passing the feed solution through simulated moving bed which comprises one or more strong acid cation exchange resin functionalized with Ca²⁺, and recovering at least one fraction enriched in allulose and free of salts, biologically derived fragments and other sugars.

One aspect of many embodiments of the invention relates to a chromatographic system for separating and recovering one or more carbohydrate molecules from a feed solution comprising one or more strong acid cation exchange resin, wherein the resin comprises a polystyrene matrix cross-linked with an aromatic crosslinker and wherein the strong acid cation exchange resin is functionalized with Na⁺, K⁺, Co²⁺, Mn²⁺, Mg²⁺ or Ca²⁺ or combination thereof.

Another aspect of many embodiments of the invention relates to a use of a chromatographic system for improving the efficiency of separation and recovery of carbohydrate molecules from an aqueous mixture of salts, sugars and carbohydrate molecules.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

Features may be described herein as part of the same or separate aspects or embodiments of the present technology for the purpose of clarity and a concise description. It will be appreciated by the skilled person that the scope of the present technology may include embodiments having combinations of all or some of the features described herein as part of the same or separate embodiments.

Various embodiments of the present technology described herein relates to methods for separation, recovery and purification of various carbohydrate molecules. The methods aim to simplify and combine multi-step processes which include the use of ion separation, ion exchange, evaporation and Simulated Moving Bed (SMB) techniques for separation of various components such as salts and sugars from a carbohydrate containing composition. As provided below, this invention is directed to a more effective and efficient process for simultaneously separating the desired carbohydrate(s) from a complex mixture comprising salts, desired carbohydrates and other undesired carbohydrates. The process is especially effective, because it permits separation of a specific desired carbohydrate of high purity even from raw materials containing contaminating substances such as inorganic salts, organic salts, color materials, disaccharides, oligosaccharides, and other similar carbohydrates. In addition, the process in accordance with the present technology has been found to have higher yields and lower production costs. The present inventors discovered that it is not necessary to use separate steps such as ion separation to separate salts from sugars and then chromatographic methods to separate one sugar from other sugars. It was found that utilizing ion separation and purification by chromatographic separation using resins, can result in the separation and recovery of a high purity carbohydrate, even from feeds containing large amounts of inorganic and/or organic salts.

Aspects of the present technology relate to a method of separating and recovering one or more carbohydrate molecules from a carbohydrate-containing feed solution. The feed solution may include one or more carbohydrates and one or more salts. The method includes passing the feed solution through an ion chromatography separation system comprising one or more strong acid cation exchange resin and recovering at least one fraction enriched in one or more carbohydrate molecules. The method may further include recovering a second fraction comprising salts. In addition to salts, the second fraction may further include one or more carbohydrate molecules. In various embodiments, the one or more carbohydrate molecule in the second fraction is different from or nonidentical to the one or more carbohydrate molecule in the first fraction.

Suitable carbohydrates which can be separated and purified using the methods of the present technology may include rare sugars; steviol glycosides; and saccharides, including, for example but not limited to monosaccharides, disaccharides, oligosaccharides and polysaccharides. Non-limiting examples of suitable saccharides include, for example, but are not limited to glucose (dextrose), fructose (levulose), galactose, sucrose, maltose, trehalose, cellobiose, chitobiose, lactose, maltodextrin, starch, and combinations thereof. Non-limiting examples of suitable steviol glycosides include, for example, but are not limited to rebaudioside A, rebaudioside B, rebaudioside C, rebaudioside D, rebaudioside D4, rebaudioside E, rebaudioside F, rebaudioside G, rebaudioside H, rebaudioside I, rebaudioside J, rebaudioside K, rebaudioside L, rebaudioside M, rebaudioside N, rebaudioside O, dulcoside A, steviolbioside, rubusoside, other steviol glycosides found in the Stevia rebaudiana plant, and mixtures of any of the foregoing, as well as stevia extracts, glycosylated steviol glycosides, and steviol glycosides prepared by chemical, enzymatic synthesis or by fermentation of recombinant microorganisms. Non-limiting examples of oligosaccharides include, for example, but are not limited to fructooligosaccharides, inulin, inulooligosaccharides, maltooligosaccharides, and combinations of any of the foregoing.

In at least one embodiment, the one or more carbohydrate molecule recovered in the first fraction includes one or more rare sugar. Suitable rare sugars include, for example, but are not limited to, allulose (D-allulose), tagatose (D-tagatose), allose, apiose, mekezitose, sorbose, and combinations of any of the foregoing. In at least one embodiment, the carbohydrate is allulose (also known as psicose). Allulose is different from other sugars in that it contains almost no caloric content, yields less than about 0.2% metabolic energy of the equivalent amount of sucrose and produces only negligible increase in blood glucose or insulin levels, which makes it attractive for various applications as a nutritive sweetener. Allulose is a rare sugar found in small quantities in jackfruit, figs, molasses and isomerized sugars. It can also be prepared enzymatically from D-fructose with an epimerase enzyme, since D-allulose is the C-3 epimer of D-fructose. In at least one embodiment, the one or more carbohydrate being separated and recovered is allulose and the method includes recovering a fraction enriched in allulose. Thus, the method results in the separation, purification and recovery of allulose from both salts and sugars (e.g., fructose).

In at least one embodiment, the one or more carbohydrate molecule being recovered in the first fraction is a rare sugar. In at least one embodiment, the one or more carbohydrate molecule being recovered in the first fraction is allulose. In at least one embodiment, the one or more carbohydrate molecule being recovered in the second fraction is nonidentical to the one or more carbohydrate molecule being recovered in the first fraction. In at least one embodiment, the one or more carbohydrate molecules being recovered in the second fraction includes one or more of fructose, dextrose, and saccharides having a degree of polymerization greater than 2 (DP2+).

The feed solution containing the carbohydrate can be obtained from natural sources or can result from a biosynthetic pathway, such as fermentation or enzymatic process for producing the carbohydrate. For example, the carbohydrate can be produced by a cell-based manufacturing method and at the end of the process the cell pellets suspended in a medium can be lysed and collected to form the feed solution. Thus, in addition to one or more carbohydrates, the feed solution may include other components resulting from the manufacturing process, such as carbon sources, energy sources, nitrogen sources, microelements, vitamins, nucleosides, nucleoside phosphates, nucleoside diphosphates, nucleoside triphosphates, organic and inorganic salts, borates, color materials, organic and mineral acids, bases, inorganic or organic materials, enzymes, solvents, buffer solutions, biological or biologically derived fragments such as nucleic acids and endotoxins, metabolic products of cell or enzymes released by the cell, toxins, water, etc. In at least one embodiment, the feed solution can be a cell lysed solution comprising an aqueous mixture of inorganic salts, biological fragments, metabolic products of cell, enzymes released by the cell, and carbohydrates.

The carbohydrate fraction in the feed solution can have a purity of greater than about 10%, greater than about 15%, greater than about 20%, greater than about 30%, greater than about 40% or greater than about 50%, and less than about 65%, less than about 60%, less than about 55%, less than about 50% or less than about 40%, on a dry solids basis. In at least one embodiment, the carbohydrate fraction in the feed solution includes a rare sugar. In at least one embodiment, the carbohydrate fraction in the feed solution has a purity of about 10% to about 80%, about 15% to about 70%, about 20% to about 60%, about 25% to about 50%, about 30% to about 55%, about 35% to about 45%, or about 30% to about 40% on a dry solids basis, or any range including and/or in-between any two of these values. In at least one embodiment, the carbohydrate fraction in the feed solution includes a rare sugar fraction having a purity of 10% to 80% on a dry solids basis. In at least one embodiment, the rare sugar fraction in the feed solution has a purity of 15% to 55% on a dry solids basis. In at least one embodiment, the rare sugar fraction in the feed solution has a purity of 25% to 50% on a dry solids basis.

The method disclosed herein improves the purity of the recovered carbohydrate so that the purity of the recovered carbohydrate, e.g., rare sugar, fraction is at least 10% greater than the purity of the carbohydrate in the feed solution on a dry solids basis. In at least one embodiment, the purity of the recovered carbohydrate, e.g., rare sugar, fraction is at least 10% greater, at least 15% greater, at least 20% greater, at least 25% greater, or at least 30% greater than the purity of the carbohydrate in the feed solution on a dry solids basis.

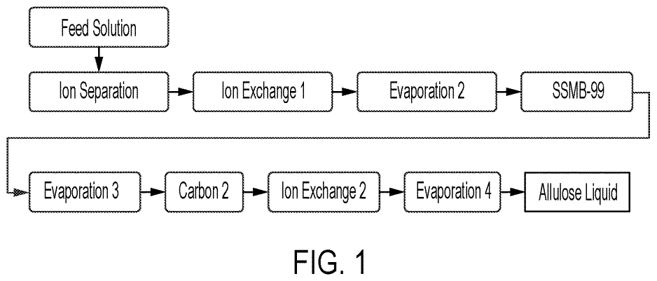

In FIG. 1, a functional flow chart for the separation and recovery of allulose is provided according to one embodiment of the present technology using a two-step ion-separation and SSMB process. The allulose-containing feed solution described herein, may first be subjected to membrane filtration and concentrated by evaporation. The feed solution is then subjected to ion separation. In this step, the feed solution is desalted by passing through a Na⁺ or a K⁺ resin such as, AmberLite™ CR99 Na/310 ion-exchange resin available from DuPont. The resulting extract contains mostly all carbohydrates whereas the raffinate contains mostly salts and optionally some carbohydrates, especially DP2+ as admixtures. This was followed by ion-exchange to remove excess salts. After desalting, the extract containing allulose along with a mixture of carbohydrates and optionally residual salts was separated using sequential simulated moving bed (SSMB) separation having columns filled with one or more strong acid cation exchange resin (Ca²⁺ form, e.g., AmberLite™ CR99 Ca/310 available from DuPont, and DIAION™ UBK-555 (Ca form) available from Mitsubishi Chemical). This SSMB system can separate allulose from a mixture which is composed of two or more carbohydrates, recovering an extract stream depleted of other carbohydrates and enriched in allulose (90% or greater) and recovering a raffinate stream raffinate containing all other carbohydrates such as dextrose, fructose, DP2+, and major amount of residual salts if any. The extract containing the separated allulose, is concentrated by evaporation followed by activated carbon decolorizing, an ion exchange purification step for polishing and a final evaporation step to obtain the liquid allulose product. The raffinate can be treated further to recover other carbohydrates. This embodiment advantageously provides separate product streams for salts, allulose and other carbohydrates.

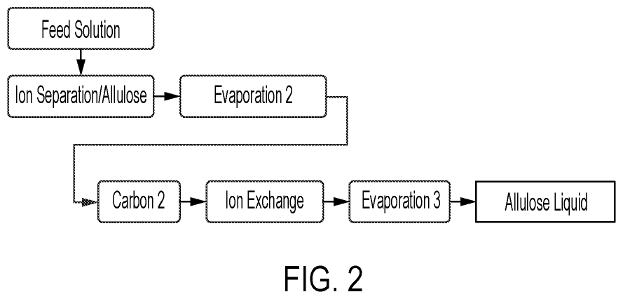

In FIG. 2, a functional flow chart for the separation and recovery of allulose is provided according to another embodiment of the present technology using a one-step ion-separation process that combined ion separation and SSMB steps. The allulose-containing feed solution described herein, may first be subjected to membrane filtration and concentrated by evaporation. The feed solution is then subjected to ion separation by passing through a Ca²⁺ resin, such as, DOWEX MONOSPHERE™ 99Ca/310 available from The Dow Chemical Company. The resulting extract is enriched in allulose (90% or greater), whereas the raffinate contains a mixture of all other carbohydrates such as dextrose, fructose, DP2+, and major amount of salts. The extract containing the separated allulose, is concentrated by evaporation followed by activated carbon decolorizing, an ion exchange purification step for removing any residual cations and salts and a final evaporation step to obtain the liquid allulose product. The resin can be regenerated with 10% CaCl₂ solution.

Aspects of the present technology relate to a method for separating a first carbohydrate comprising from an aqueous feed comprising the first carbohydrate and at least one other, nonidentical component selected from sugars and salts. The method includes passing the aqueous feed over one or more resins, and collecting a portion of the aqueous phase exiting the resin that contains the first carbohydrate, wherein the one or more resin includes a strong acid cation exchange resin.

The feed solution may include two or more carbohydrates, including the first carbohydrate to be separated, and salts. In one embodiment, the first carbohydrate can be separated from the other non-identical carbohydrates and salts using a single chromatography separation step. Thus, in one embodiment, a method of separating and recovering a first carbohydrate from a feed solution includes passing the feed solution through a chromatography separation system which comprises one or more strong acid cation exchange resin; and recovering a first fraction enriched in said first carbohydrate and a second fraction comprising one or more carbohydrates and salts.

In another embodiment, the first carbohydrate can be separated from the other carbohydrates and salts using two chromatography separation steps, one to separate most of the carbohydrates from the salts and the second to separate the first carbohydrate from the other non-identical carbohydrates. Thus, in one embodiment, a method of separating and recovering a first carbohydrate from a feed solution comprising two or more carbohydrates and salts, includes passing the feed solution through a first chromatography separation system which comprises one or more strong acid cation exchange resin functionalized with a monovalent metal ion; recovering a first fraction enriched in said two or more carbohydrates and a second fraction comprising salts with admixture of unrecovered in the first fraction carbohydrates; subjecting the first fraction to an ion exchange purification process to obtain a third fraction comprising two or more carbohydrates; passing the third fraction through a second chromatography separation system which comprises one or more strong acid cation exchange resin functionalized with a divalent metal ion; and recovering a fourth fraction enriched in said first carbohydrate and a fifth fraction comprising one or more carbohydrates.

The feed solution containing the two or more carbohydrates, including the first carbohydrate to be separated, and salts can be passed through one or more ion chromatography separation systems comprising one or more strong acid cation exchange resin. Alternatively, an amphoteric ion-exchange resin can also be used. Suitable amphoteric resins may have a quaternary ammonium group and carboxy group incorporated into the cross-linked polystyrene backbone. Suitable resin structures may include macroporous or gel resins. In at least one embodiment, the strong acid cation exchange resin is in a gel bead form. The strong acid cation exchange resin can have a Polystyrene (PS) matrix and can have carbonyl or sulfonate groups with hydrogen, potassium, and sodium as counterions. The strong acid cation exchange resin can be in a monovalent or divalent cation form. In at least one embodiment, the strong acid cation exchange resin is functionalized with monovalent ions (e.g., alkali metal ions) or a combination of two or more thereof. In at least one embodiment, the strong acid cation exchange resin is functionalized with divalent metal ions (e.g., alkaline earth metal ions) or a combination of two or more thereof. In certain embodiments, the monovalent cations, such as K⁺, Na⁺ may be present on the surface of cation resin. In at least one embodiment, the cation composition is defined and equilibrated with cation present in the feed solution. Thus the strong acid cation exchange resin can be functionalized with Ca²⁺, Co²⁺, Na⁺, K⁺, Mg²⁺, Mnⁿ⁺, or a combination of the cations with variable proportions. The strong acid cation exchange resin is suitably cross-linked with an aromatic crosslinker such as divinylbenzene (DVB), divinyltoluene, divinylxylene, divinylnaphthalene, trivinylbenzene, divinvldiphenyl sulfone, alkylene diacrylates and alkylene dimethacrylates. In at least one embodiment, the crosslinker is divinylbenzene. The DVB content can be varied to obtain the desired separation performance. The polystyrene-divinylbenzene (PS-DVB) stationary phase has hydrophobic properties and with a high chemical and thermal stability. In at least one embodiment, the styrene-divinylbenzene resin is in a divalent form and is functionalized with Ca²⁺. In at least one embodiment, a calcium functionalized resin may be used to first separate the desired carbohydrate from the salts and nonidentical carbohydrates and then an ion exchange purification step to obtain a fraction containing a purified first carbohydrate.

The strong acid cation exchange resin has a median bead diameter of from about 100 to about 500 microns, including, but not limited to, about 150 to about 450 microns, about 200 to about 400 microns, about 250 to about 350 microns, or about 300 to about 350 microns. In at least one embodiment, the strong acid cation exchange resin has a median bead diameter of about 300 to about 350 microns. Non-limiting examples of representative resins include DOWEX MONOSPHERE™ 99Ca/310 available from The Dow Chemical Company, AmberLite™ CR99 Na/310 and AmberLite™ CR99 Ca/310 available from DuPont, and DIAION™ UBK-555 (Ca form) available from Mitsubishi Chemical. Non limiting examples of suitable amphoteric resins include, Macronet™ MN202 available from Purolite and DIAION™ AMP03 available from Mitsubishi Chemical.

The feed solution is introduced into the resin packed bed and one or more carbohydrate rich product fractions can be recovered during the feed stage and/or one or more other stages. During the elution phase, the eluent is fed to the resin packed bed. The feed solution and the eluent can be fed separately or simultaneously. The method may also include a circulation phase, wherein essentially no feed solution or eluent is fed to the resin bed and no product is recovered. Suitable liquid eluents such as water, glycerol or a portion of the collected residue fraction can be used to elute and collect the one or more carbohydrate rich fraction. In at least one embodiment, the eluent for the ion chromatography separation system is water.

The separation may be conducted using any suitable chromatographic method known in the art, including, but not limited to, simulated moving bed (SMB), sequential simulated moving bed (SSMB) method, a batch method, an intermittent simulated moving bed (ISMB) method, other proprietary chromatographic methods or combinations thereof. In at least one embodiment, the separation is performed by a sequential simulated moving bed method. An example of the simulated moving bed separation system which can be used for the chromatographic separation is the system described in WO2016073881 and/or references cited there, the entire teaching of which are incorporated herein by reference in their entirety. In a continuous SSMB system, all fluid flows are continuous and may include the feed solution and eluent feed, separation profile circulation, and product recovery. In a sequential SMB system, all the steps are conducted in a predetermined sequential and may optionally be repeated. In at least one embodiment, a first chromatography separation system is an ion chromatography system which includes one or more strong acid cation exchange resin functionalized with an alkali metal ion (e.g., Na⁺). In at least one embodiment, a second chromatography separation system is a sequential simulated moving bed which includes one or more strong acid cation exchange resin functionalized with an alkaline earth metal ion (e.g., Ca²⁺).

The chromatographic separation system can include a plurality of zones including separation zones, collection zones, washing zones, equilibration zones and/or regeneration zones. The chromatographic separation systems may provide multiple separation zones, for example 3 or more separation zones and options for collection of multiple products and co-products, for example 2 or more collection zones. For example, in one application the products can be recovered from zone 1 of a chromatographic system by elution with water, zone 2 can be used for separation of component(s) of interest from others, zone 3 can be dedicated for injection of feed and simultaneous separation of component(s) of interest from others, zone 4 can be used for regeneration of resin or used as safety zone. Additional zones can be added to aid regeneration of resin, serve as safety zones, or be used for recovery of other fractions of interest (where 3 or more fractions require to be recovered). In at least one embodiment, the chromatographic separation system comprises a plurality of separation zones and collection zones allowing recovery of two or more fractions or streams.

The chromatographic separation systems may provide one or more zones for continuous or periodic regeneration of chromatographic resin. The latter can be achieved by a regeneration solution that is applied to the packed bed. Depending on the chemical properties of the chromatography medium, this solution may be either a strong alkaline solution, a strong acidic solution, a chaotropic buffer, an organic solvent, e.g. ethanol, an aqueous buffer supplemented with an organic solvent, or an aqueous buffer with an ionic or non-ionic detergent. The regenerating solution is such that it is can remove the bound fractions from the resin. The regenerating solution may be the feed solution itself or it may different from the feed solution and applied to the chromatographic medium separately from the feed solution. Suitable regeneration solutions may include, but are not limited to, NaOH, Ca(OH)₂, NaCl, KOH, KCl and CaCl₂), or combinations thereof, of suitable concentration.

Aspects of the present technology relate to a method for improving the efficiency of separation and recovery of carbohydrate molecules from an aqueous mixture of salts, sugars and other carbohydrate molecules. In at least one embodiment, the method includes improving the efficiency of separation and recovery of allulose from an aqueous mixture of salts and other carbohydrate molecules.

In one aspect, provided is a method of separating and recovering allulose from a feed solution. The method includes passing the feed solution through a chromatography separation system which comprises one or more strong acid cation exchange resin functionalized with Ca²⁺, and recovering at least one fraction enriched in allulose and free of salts, biologically derived fragments and other sugars.

In another aspect, provided is a method of separating and recovering allulose from a feed solution comprising of two or more carbohydrates and salts. The method includes passing the feed solution through a first chromatography separation system which comprises one or more strong acid cation exchange resin functionalized with Na⁺; recovering a first fraction enriched in said two or more carbohydrates and a second fraction comprising salts and optionally residual carbohydrates not recovered in the first fraction; subjecting the first fraction to an ion exchange purification process to obtain a third fraction comprising two or more carbohydrates; passing the third fraction through a second chromatography separation system which comprises one or more strong acid cation exchange resin functionalized with Ca²⁺; and recovering a fourth fraction enriched in allulose and a fifth fraction comprising one or more carbohydrates.

At the end of the chromatographic separation process at least one fraction enriched in one or more carbohydrate molecules is recovered. The desired carbohydrate, such as for example rare sugars are separated from other carbohydrate and non-carbohydrate components, including, but not limited to sucrose, fructose, glucose, dextrose, oligomers of dextrose, fragments of RNA and/or DNA, biological endotoxins, amino acids, inorganic salts, and combinations thereof. In at least one embodiment, the recovered carbohydrate includes a rare sugar selected from allulose (D-allulose), tagatose (D-tagatose), allose, apiose, mekezitose, sorbose, or combinations thereof. In at least one embodiment, the one or more carbohydrate molecules comprises allulose and the method comprises recovering a fraction enriched in allulose. In at least one embodiment, the recovered allulose is separated from one or more of glucose, fructose, dextrose, saccharides having a degree of polymerization greater than 2 (DP2+), fragments of RNA and/or DNA, biological endotoxins, amino acids, inorganic salts, and combinations thereof. In at least one embodiment, the recovered allulose is separated from salts, DP2+, dextrose, and fructose.

The recovered first carbohydrate fraction can be subjected to further treatment steps including, but not limited to, ion-exchange purification, evaporation and decolorization. The first carbohydrate thus obtained can have a purity of greater than about 60% or more on a dry solids basis. In at least one embodiment, the recovered first carbohydrate includes recovered rare sugar having a purity of about 60% or more. This includes purity of about 65% or more, about 70% or more, about 75% or more, about 80% or more, about 85% or more, about 90% or more, about 95% or more, or about 98% or more, on a dry solids basis. In at least one embodiment, the recovered first carbohydrate has a purity of about 90% or more, about 91% or more, about 92% or more, about 93% or more, about 94% or more, about 95% or more, about 96% or more, about 97% or more, about 98% or more, or about 99% or more, on a dry solids basis. In at least one embodiment, the first carbohydrate has a purity of about 90% to about 99%, about 90% to about 98%, about 90% to about 97%, about 90% to about 96%, or about 90% to about 95% on a dry solids basis, or any range including and/or in-between any two of these values. In at least one embodiment, the rare sugar has a purity of 90% to 99% on a dry solids basis. In at least one embodiment, the purity of the first carbohydrate is at least 10% greater than the purity of that carbohydrate in the feed solution on a dry solids basis. In at least one embodiment, the first carbohydrate is allulose having a purity of 90% to 99% on a dry solids basis. The final carbohydrate solution has allulose concentration of 70 brix or more, for example, 75 brix or more, 80 brix or more or 85 brix or more. In one or more embodiments, the final carbohydrate solution has allulose concentration of 70 brix to 95 brix, for example, 75 brix to 90 brix or 80 brix to 85 brix.

The recovered carbohydrate-rich fraction can be used as such or further treated to obtain the one or more carbohydrates in solid or liquid form and having the desired purity. The recovered carbohydrate can optionally be further purified using known methods such as chromatographic purification, crystallization, ultrafiltration, nanofiltration and the like, or combinations thereof.

The method may provide a carbohydrate yield of at least 80%, such as at least 85%, at least 90%, or at least 95%. In at least one embodiment, the method provides a yield of about 80% to about 99%, such as about 85% to about 95%, or about 95% to about 98% or any range including and/or in-between any two of these values.

The method may optionally include one or more additional treatment steps after the separation and recovery. The one or more post-treatment steps may include, but are not limited to carbon treatment, evaporation and ion exchange purification. Thus, the recovered carbohydrate-enriched fraction may be further subjected to one or more of these post-treatment steps including evaporation, carbon treatment and ion exchange purification. The ion exchange purification can employ a strongly acidic cation exchange resin or a weakly basic anion exchange resin such as Puropack® PPC150SH, Purolite) A510SMBPLUS, and Purolite® A133S, AmberLite™ IRA96, AmberLite™ FPC88 MB, AmberLite™ FPA66, and the like.

Aspects of the present technology relate to a method of method of separating and recovering allulose from a feed solution. The method may include contacting the feed solution with a suitable resin using ion chromatography or simulated moving bed, wherein the resin comprises one or more strong acid cation exchange resins functionalized with Ca²⁺, Co²⁺, Na⁺, K⁺, Mg²⁺, Mnⁿ⁺ (e.g., Mn²⁺) or a combination of the cations with variable proportions. In at least one embodiment, the strong acid cation exchange resin is functionalized with an alkaline earth metal ion or a combination of two or more thereof. In at least one embodiment, the strong acid cation exchange resin is in a divalent cation form. The method may further include recovering at least one fraction enriched in allulose and which is free of salts, biologically derived fragments and other sugars.

In another aspect, a chromatographic system for separating and recovering one or more carbohydrate molecules from a feed solution is provided. The chromatographic system includes one or more strong acid cation exchange resin, wherein the resin comprises a polystyrene matrix cross-linked with an aromatic crosslinker and wherein the strong acid cation exchange resin is in a Ca²⁺ form. The chromatographic system is used for improving the efficiency of separation and recovery of carbohydrate molecules from an aqueous mixture of salts, sugars and carbohydrate molecules.

The methods and devices disclosed herein advantageously provide separation and purification of carbohydrates such as allulose, not only from other carbohydrates such as fructose glucose, and oligomers (DP2+), but also from salts such as inorganic salts, small charges biological molecules, phosphates of carbohydrates. The method is effective even for separation of complex mixtures of carbohydrates and large amounts of salts, up to 2, 5 or even 10 times more salts than the classic mixtures, wherein the conventional methods such as ion-exchange and SSMB prove to be ineffective. When large amounts of salts are present the purification process typically requires more advanced desalination processes, e.g., Capacitive Deionization (CDI). The ion-separation/SSMB one- or two-step method depicted in FIGS. 1 and 2 and described herein to separate carbohydrates such as allulose from everything else is advantageous over multi-step processes which require ion separation, evaporation, and chromatographic separation in that it reduces costs, time and complexity and results in improved yields and purity. The methods also provides a side stream containing valuable carbohydrates along with salts and biomolecules. The side stream can have added value by recycling back into the process or for using in other processes, e.g., fermentation.

The following terms are used throughout and are as defined below.

Strong acid cationic exchange resins are known in the industry and available from various suppliers. Without limiting the full scope of the term as it is understood in the art, strong acid cationic exchange resins are generally products comprising a moiety that acts a strong acid in operation. Although not intended to limit the full scope of the term is common that the moiety is a sulfonic acid group.

As used herein and in the appended claims, singular articles such as “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of refereeing individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified. The expression “comprising” means “including, but not limited to.” Thus, other non-mentioned substances, additives, carriers, or steps may be present. Unless otherwise specified, “a” or “an” means one or more.

Unless otherwise indicated, all numbers expressing quantities of properties, parameters, conditions, and so forth, used in the specification and claims are to be understood as being modified in all instances by the term “about.” Accordingly, unless indicated to the contrary, the numerical parameters set forth in the following specification and attached claims are approximations. Any numerical parameter should at least be construed in light of the number reported significant digits and by applying ordinary rounding techniques. The term “about” when used before a numerical designation, e.g., temperature, time, amount, and concentration including range, indicates approximations which may vary by (+) or (−) 10%, 5% or 1%.

All percentages specified herein are calculated by weight unless otherwise indicated.

As will be understood by one of skill in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

The technology disclosed in this specification can better understood with reference to the following aspect, which are illustrative and are not intended to limit the full scope of the technology disclosed in this specification.
1. A method of separating and recovering a first carbohydrate from a feed solution comprising two or more carbohydrates and salts, said method comprising: passing the feed solution through a chromatography separation system which comprises one or more strong acid cation exchange resin; and recovering a first fraction enriched in said first carbohydrate and a second fraction comprising one or more carbohydrates and salts.
2. The method of claim 1, wherein the strong acid cation exchange resin comprises divalent cations, monovalent cations, and cations equilibrated with the cations present in the feed solution, or a combination thereof.
3. The method of claim 1 or claim 2, wherein the divalent cations are selected from the group consisting of Ca²⁺, Co²⁺, Mg²⁺, Mn²⁺ or a combination of two or more thereof; and the monovalent cations are selected from the group consisting of Na⁺, K⁺ or a combination thereof.
4. The method of claim 3, wherein the strong acid cation exchange resin is in a gel bead form.
5. The method of any one of the preceding claims, wherein the strong acid cation exchange resin has a median bead diameter of from 100 to 500 microns.
6. The method of any one of the preceding claims, wherein the strong acid cation exchange resin is a resin with a polystyrene matrix.
7. The method of claim 6, wherein the strong acid cation exchange resin is cross-linked with divinylbenzene.
8. The method of any one of the preceding claims, wherein the feed solution is a cell lysed solution comprising an aqueous mixture of inorganic salts, biological fragments, metabolic products of cell, enzymes released by the cell and carbohydrates.
9. The method of any one of the preceding claims, wherein the first carbohydrate comprises a rare sugar and the method comprises recovering a fraction enriched in a rare sugar.
10. The method of claim 9, wherein the rare sugar is allulose.
11. The method of claim 10, wherein the rare sugar fraction in the feed solution has a purity of 10% to 80% on a dry solids basis.
12. The method of any one of claims 9 to 11, wherein the purity of the recovered rare sugar fraction is at least 10% greater than the purity of the rare sugar fraction in the feed solution on a dry solids basis.
13. The method of any one of claims 9 to 12, wherein the recovered rare sugar fraction has a purity of 60% or more on a dry solids basis.
14. The method of claim 13, wherein the recovered carbohydrate fraction has a purity of more than 90% on a dry solids basis.
15. The method of any one of claims 9 to 14, wherein the method provides a rare sugar yield of at least 80%.
16. The method of any one of claims 9 to 15, wherein the rare sugar is separated from a feed solution comprising sucrose, fructose, dextrose, oligomers of dextrose, fragments of RNA and/or DNA, biological endotoxins, amino acids, and inorganic salts.
17. The method of claim 1, wherein the one or more carbohydrate molecules in the second fraction is selected from the group consisting of fructose, dextrose, saccharides having a degree of polymerization greater than 2.
18. The method of any one of the preceding claims, wherein the chromatography separation system comprises a chromatographic method selected from ion chromatography, simulated moving bed, sequential simulated moving bed, a batch method, an intermittent simulated moving bed, or a combination or two or more thereof.
19. The method of claim 18, wherein the chromatography separation system comprises ion chromatography or sequential simulated moving bed.
20. The method of claim 19, further comprising ion exchange purification.
21. The method of any one of the preceding claims, wherein the chromatographic separation system comprises a plurality of separation zones and collection zones configured to allow recovery of two or more fractions.
22. The method of any one of the preceding claims, wherein the chromatographic separation system comprises a regeneration zone for continuous or periodic regeneration of the resin, wherein a regeneration solution is applied to the bed.
23. The method of claim 22, wherein the regeneration solution comprises NaOH, NaCl, KOH, KCl, Ca(OH)₂, or CaCl₂).
24. A method of separating and recovering a first carbohydrate from a feed solution comprising two or more carbohydrates and salts, said method comprising: passing the feed solution through a first chromatography separation system which comprises one or more strong acid cation exchange resin functionalized with monovalent metal ions; recovering a first fraction enriched in said two or more carbohydrates and a second fraction comprising salts; subjecting the first fraction to an ion exchange purification process to obtain a third fraction comprising two or more carbohydrates; passing the third fraction through a second chromatography separation system which comprises one or more strong acid cation exchange resin functionalized with divalent metal ions; and recovering a fourth fraction enriched in said first carbohydrate and a fifth fraction comprising one or more carbohydrates.
25. The method of claim 24, wherein the monovalent metal ions are selected from Na⁺, K⁺ or a combination thereof.
26. The method of claim 24, wherein the divalent metal ions are selected from the group consisting of Ca²⁺, Co²⁺, Mg²⁺, Mn²⁺ or a combination of two or more thereof.
27. The method of any one of claims 24-26, wherein the first chromatography separation system comprises ion chromatography.
28. The method of any one of claims 24-27, wherein the second chromatography separation system comprises sequential simulated moving bed method.
29. The method of any one of claims 24-28, wherein the first carbohydrate comprises a rare sugar and the method comprises recovering a fraction enriched in a rare sugar.
30. The method of claim 29, wherein the rare sugar is allulose.
31. The method of any one of claims 24-30, wherein the method provides a rare sugar yield of at least 80%.
32. The method of any one of claims 24-31, wherein the one or more carbohydrate molecules in the fifth fraction is selected from the group consisting of fructose, dextrose, saccharides having a degree of polymerization greater than 2.
33. A method of separating and recovering allulose from a feed solution, the method comprising: passing the feed solution through a chromatography separation system which comprises one or more strong acid cation exchange resin functionalized with Ca²⁺, and recovering at least one fraction enriched in allulose and having reduced content of salts, biologically derived fragments and other sugars.
34. A method of separating and recovering allulose from a feed solution comprising two or more carbohydrates and salts, said method comprising: passing the feed solution through a first chromatography separation system which comprises one or more strong acid cation exchange resin functionalized with Na⁺; recovering a first fraction enriched in said two or more carbohydrates and a second fraction comprising salts; subjecting the first fraction to an ion exchange purification process to obtain a third fraction comprising two or more carbohydrates; passing the third fraction through a second chromatography separation system which comprises one or more strong acid cation exchange resin functionalized with Ca²; and recovering a fourth fraction enriched in allulose and a fifth fraction comprising one or more carbohydrates.
35. The method of claim 33 or claim 34, wherein the feed solution is a cell lysed solution comprising an aqueous mixture of inorganic salts, biological fragments, metabolic products of cell, enzymes released by the cell and carbohydrates.
36. The method of claim 34, wherein the one or more carbohydrate molecules in the fifth fraction is selected from the group consisting of fructose, dextrose, saccharides having a degree of polymerization greater than 2.
37. A chromatographic system for separating and recovering one or more carbohydrate molecules from a feed solution comprising two or more carbohydrates and salts, the system comprising one or more strong acid cation exchange resin, wherein the resin comprises a polystyrene matrix cross-linked with an aromatic crosslinker and wherein the strong acid cation exchange resin is functionalized with Na⁺, K⁺, Co²⁺, Mn²⁺, Mg²⁺ or Ca²⁺ or combination thereof.
38. A method of separating and recovering a first carbohydrate from a feed solution comprising two or more carbohydrates and salts, said method comprising: passing the feed solution through a chromatography separation system which comprises one or more strong acid cation exchange resin to separate from the feed stock a first fraction enriched in a first carbohydrate and a second fraction comprising a second carbohydrate and one or more salts; and recovering the first fraction by applying step selected from the group consisting of evaporation, discoloration, purification and mixtures thereof wherein the first carbohydrate is a rare sugar.
39. The method of claim 38, wherein the strong acid cation exchange resin comprises divalent cations, monovalent cations, and cations equilibrated with the cations present in the feed solution, or a combination thereof.
40. The method of any preceding claim, wherein the strong acid cation exchange resin is cross-linked with divinylbenzene.
41. The method of any one of the preceding claims, wherein the feed solution is a cell lysed solution comprising an aqueous mixture of inorganic salts, biological fragments, metabolic products of cell, enzymes released by the cell and carbohydrates.
42. The method of any preceding claim wherein the rare sugar is allulose.
43. The method of any preceding claim wherein the recovered rare sugar fraction has a purity of 60% or more on a dry solids basis or more than 90%.
44. The method of any preceding claim, wherein the method provides a rare sugar yield of at least 80%.
45. The method of any preceding claim, wherein the chromatography separation system comprises ion chromatography.
46. The method of any one of the preceding claims, wherein the chromatographic separation system comprises a plurality of separation zones and collection zones configured to allow recovery of two or more fractions.
47. The method of any one of the preceding claims, wherein the chromatographic separation system comprises a regeneration zone for continuous or periodic regeneration of the resin, and further comprises a step wherein a regeneration solution is applied to regenerate the resin.
48. A method of separating and recovering a first carbohydrate from a feed solution comprising two or more carbohydrates and salts, said method comprising: passing the feed solution through a chromatography separation system which comprises means for separating a first fraction enriched in the first carbohydrate from a second fraction comprising one or more carbohydrates and salts; and recovering the first fraction by applying step selected from the group consisting of evaporation, discoloration, purification and mixtures thereof wherein the first carbohydrate is a rare sugar.
49. The method of claim 48 wherein the rare sugar is allulose.
50. The method of claim 48 or 49 wherein the recovered rare sugar fraction has a purity of 60% or more on a dry solids basis or more than 90%.
51. The method of any one of claims 48 or 50, wherein the method provides a rare sugar yield of at least 80%.
52. The method of any one of claims 48 to 51 wherein the means for separating a first fraction enriched in the first carbohydrate from a second fraction comprising one or more carbohydrates and salts comprises a strong acid cation exchange resin.
53. The method of any one of claims 48 to 52 wherein the chromatographic separation system further comprises a regeneration zone for continuous or periodic regeneration of the resin, and further comprises a step wherein a regeneration solution is applied to regenerate the resin.
54. The method of any claim 52 or 53 wherein the strong acid cation exchange resin is cross-linked with divinylbenzene.
55. The method of claims 48 to 54, wherein the feed solution is a cell lysed solution comprising an aqueous mixture of inorganic salts, biological fragments, metabolic products of cell, enzymes released by the cell and carbohydrates.
56. The method of any foregoing claim, wherein the one or more carbohydrate molecules in the second fraction is selected from the group consisting of fructose, dextrose, saccharides having a degree of polymerization greater than 2.
57. The method of claim 40 or 54, wherein the regeneration solution comprises NaOH, NaCl, KOH, KCl, Ca(OH)₂, or CaCl₂.

Various embodiments will be further clarified by the following examples, which are in no way intended to limit this disclosure thereto.

### EXAMPLES

### Example 1—Pulse Test

To test feasibility of chromatographic separation of allulose from salts and other carbohydrate a pulse testing experiments were performed. Chromatographic pulse testing was conducted using the testing conditions summarized in Table 2.

TABLE 2
chromatographic pulse testing parameters

| | Residual DP2+: ~74185 |
|---|---|
| | Allulose: ~120300 |
| | Fructose: ~1435 |
| Approximate Feed composition | Glucose: ~156 |
| (g/L) | Total salts: ~156 |
| Injected Volume (BV) | 0.067 |
| Injected Concentration (Bx) | 52 Bx |
| Flow Rate (BV/h) | 2.5 |
| Column Temperature (° C.) | 45 |
| Column Diameter (mm) | 20 |
| Column Length (cm) | 25 |
| Total Bed Volume (mL) | 150 |

Selected cationic resins and amphoteric resins DOWEX MONOSPHERE™ 99Ca/310, Macronet™ MN202, DIAION™ UBK-555 (Ca form) and DIAION™ AMP03 were pulse-tested with ˜52% DS syrup. All resins revealed signs of separation of sugars from salts. The 99Na/310 resin allowed separation of sugars from salts and the 99Ca/310 resin allowed separation of allulose from salts, DP2+, dextrose, and fructose.

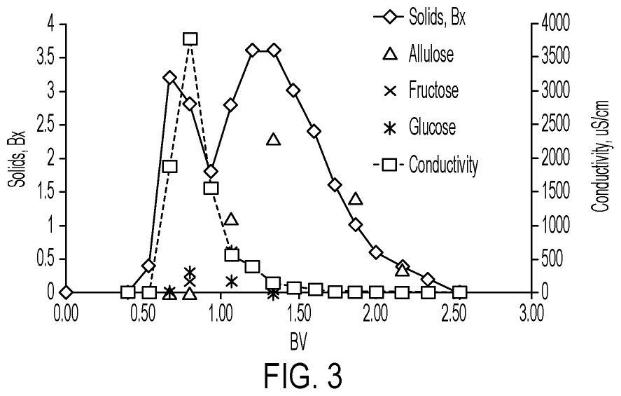

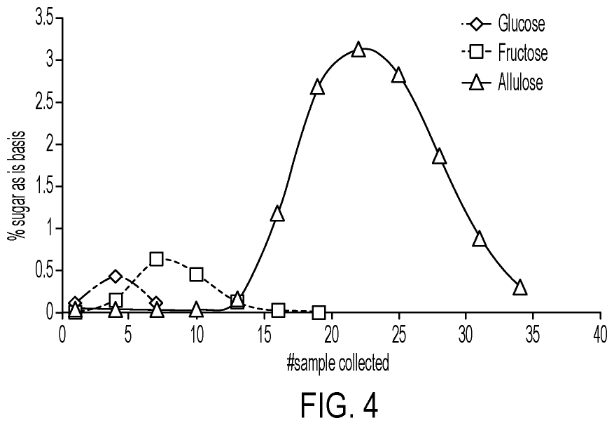

Sample resins listed above were heated to 45° C., and injected feed was preheated to 45° C. Water was pumped through the column at the flowrate of the test (˜2.5 BV/hr). To start the test, 0.067 BV (10 mL) of heated 52 Brix feed solution was injected into the column. Right after injection flow of eluent (DI water at 45° C.) started. After 0.3 BV (45 mL of DI water) of elution the collection of samples started. Samples were collected manually in 15 to 20 mL portions (measured precisely using analytical balance). Each fraction was analyzed for total solids concentration using calibrated hand held Brixmeter and for conductivity by using conductivity meter (Traceable, model 89094-958). Selected fractions with solids content above zero were analyzed for concentration of carbohydrates (except DP2+) using LC/MS. Based on results of analysis pulse-test graphs were plotted using bed volumes (calculated from fraction number and volume collected till that point) on the x-axis and response (Brix or conductivity) on the y-axis. Results for pulse-test of DOWEX MONOSPHERE™ 99Ca/310 are illustrated in FIG. 3. The results indicate that the 99Ca/310 resin can separate allulose from other sugars as well as from salts: i.e., peak of conductivity overlaps with fructose, glucose, and DP2+ (not shown on the graph), while allulose elutes at longer residence times. FIG. 4 shows that allulose can be separated from glucose and fructose using UBK-555 99Ca/220 μm resin.

### Example 2—Regeneration Test for 99Ca/310 Resin

The feed solution contains approximately ˜15 g/L of different salts including salts of calcium, cobalt, magnesium, manganese, sodium, and potassium, etc. with counter-ions represented by chloride, phosphates, nitrate, etc. Charge organic molecules such as organic phosphates, phospholipids, fragments of nucleic acids can be parts of the broth. Thus, it is natural to expect that resin (e.g., 99Ca/310) can partially loose it original separation efficiency.

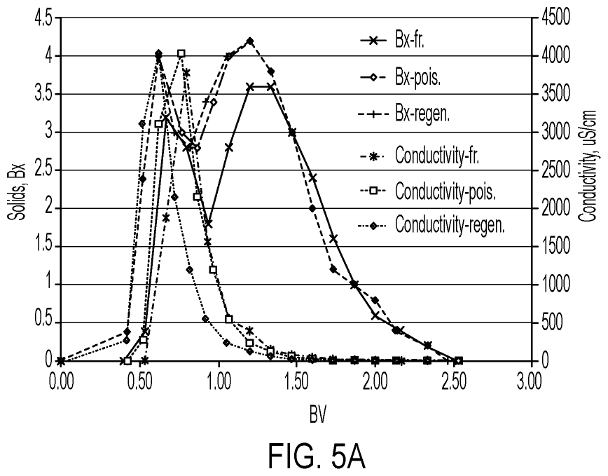

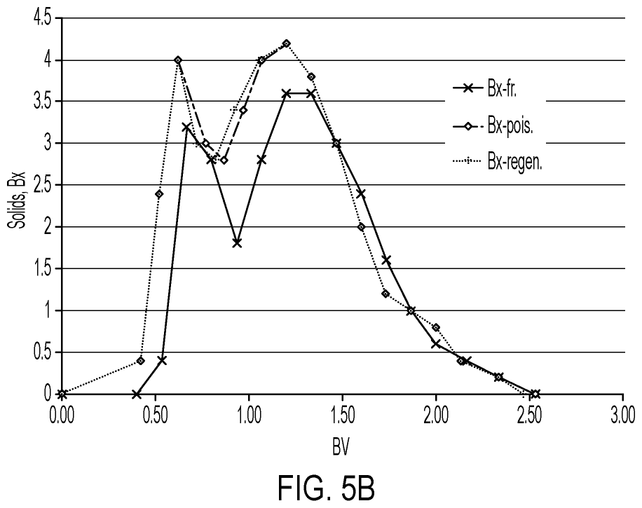

To test whether the resin will lose separation efficiency while in operation ˜20 BV of feed solution were processed though the resin bed. Pulse-tests, similar to one described in example #1, were repeated. After that resin was regenerated with 4 BV of 10% w/w solution of CaCl₂ in deionized water. The results of the testing are show in FIGS. 5A and 5B.

The graph in FIG. 5A shows the elution profiles (total solid and conductivity) for feed eluting from fresh (fr.), poisoned (pois. and pois. rep.). and regenerated (regen.) 99Ca/310 resin. The graph in FIG. 5B shows only total solids elution profiles for fresh, poisoned, and regenerated resin. From both graphs it follows that fresh, poisoned, and regenerated resins behave similarity revealing two distinct elution peaks. Based on results presented on FIG. 3 the first peak can be associated with elution of salts, DP2+, glucose, and fructose. The second peak can be associated with elution of allulose only.

1. A method of separating and recovering a first carbohydrate from a feed solution comprising two or more carbohydrates and salts, said method comprising:
passing the feed solution through a chromatography separation system which comprises one or more strong acid cation exchange resin to separate from the feed stock a first fraction enriched in a first carbohydrate and a second fraction comprising a second carbohydrate and one or more salts; and
recovering the first fraction by applying step selected from the group consisting of evaporation, discoloration, purification and mixtures thereof
wherein the first carbohydrate is a rare sugar.

2. The method of claim 1, wherein the strong acid cation exchange resin comprises divalent cations, monovalent cations, and cations equilibrated with the cations present in the feed solution, or a combination thereof.

3. The method of claim 1, wherein the strong acid cation exchange resin is cross-linked with divinylbenzene.

4. The method of claim 1, wherein the feed solution is a cell lysed solution comprising an aqueous mixture of inorganic salts, biological fragments, metabolic products of cell, enzymes released by the cell and carbohydrates.

5. The method of claim 1 wherein the rare sugar is allulose.

6. The method of claim 1 wherein the recovered rare sugar fraction has a purity of 60% or more on a dry solids basis.

7. The method of claim 1, wherein the method provides a rare sugar yield of at least 80%.

8. The method of claim 1, wherein the chromatography separation system comprises ion chromatography.

9. The method of claim 1, wherein the chromatographic separation system comprises a plurality of separation zones and collection zones configured to allow recovery of two or more fractions.

10. The method of claim 1, wherein the chromatographic separation system comprises a regeneration zone for continuous or periodic regeneration of the resin, and further comprises a step wherein a regeneration solution is applied to regenerate the resin.

11. A method of separating and recovering a first carbohydrate from a feed solution comprising two or more carbohydrates and salts, said method comprising:
passing the feed solution through a chromatography separation system which comprises means for separating a first fraction enriched in the first carbohydrate from a second fraction comprising one or more carbohydrates and salts; and
recovering the first fraction by applying step selected from the group consisting of evaporation, discoloration, purification and mixtures thereof
wherein the first carbohydrate is a rare sugar.

12. The method of claim 11 wherein the rare sugar is allulose.

13. The method of claim 11 wherein the recovered rare sugar fraction has a purity of 60% or more on a dry solids basis.

14. The method of claim 11, wherein the method provides a rare sugar yield of at least 80%.

15. The method of claim 11 wherein the means for separating a first fraction enriched in the first carbohydrate from a second fraction comprising one or more carbohydrates and salts comprises a strong acid cation exchange resin.

16. The method of claim 11 wherein the chromatographic separation system further comprises a regeneration zone for continuous or periodic regeneration of the resin, and further comprises a step wherein a regeneration solution is applied to regenerate the resin.

17. The method of claim 11 wherein the means for separating a first fraction enriched in the first carbohydrate from a second fraction comprising one or more carbohydrates and salts comprises a strong acid cation exchange resin and wherein the strong acid cation exchange resin is cross-linked with divinylbenzene.

18. The method of claim 11, wherein the feed solution is a cell lysed solution comprising an aqueous mixture of inorganic salts, biological fragments, metabolic products of cell, enzymes released by the cell and carbohydrates.

19. The method of claim 11, wherein the one or more carbohydrate molecules in the second fraction is selected from the group consisting of fructose, dextrose, saccharides having a degree of polymerization greater than 2.

20. The method of claim 11, wherein the regeneration solution comprises a chemical selected from the group consisting of sodium hydroxide, sodium chloride, potassium hydroxide, potassium chloride, calcium hydroxide, and calcium chloride.
